(19) United States
(12) Patent Application Publication
(10) Pub. No.: US 2019/0361983 A1
(43) Pub. Date: Nov. 28, 2019

(54) SENSOR FUSION FOR GENERATING QUERIES

(71) Applicant: Microsoft Technology Licensing, LLC, Redmond, WA (US)

(72) Inventors: Bin WANG, Bellevue, WA (US); Lei ZHANG, Redmond, WA (US); Ying CHIN, Bellevue, WA (US); Dejun ZHANG, Bellevue, WA (US); Robert Yu ZHU, Bellevue, WA (US); Shu PENG, Redmond, WA (US); Daryl Alan WELSH, Bellevue, WA (US)

(21) Appl. No.: 15/989,736

(22) Filed: May 25, 2018

(51) Int. Cl. G06F 17/30; G06K 9/62; G06T 7/70

(52) U.S. Cl. CPC G06F 17/30038; G06F 17/30029; G06F 17/30861; G06K 9/6217; G06T 7/70; G06F 17/30967

(57) ABSTRACT

The disclosed technology provides a provides a method for generating a query. The method includes receiving at least sensed data of a first sensor collected from a first sensor on a querying device and sensed data of a second sensor collected from a second sensor on the querying device. One or more numeric parameters are obtained by transforming the sensed data of the first sensor. The sensed data of the second sensor is analyzed to identify one or more features using pattern recognition and the one or more features are extracted from the sensed data of the second sensor. The method further includes generating a query based at least on the numeric parameters obtained from the sensed data of the first sensor and the features extracted from the sensed data of the second sensor.

### BACKGROUND

Users sometimes want to share multimedia data between user devices, for example, when many users are using their devices to capture data of a significant event at the same time from different vantage points. Multimedia data may be shared on the internet or other sharing platforms between users who are known to each other or multimedia data may be shared with the public via the internet. However, it can be challenging to search for and share multimedia data between two devices that are previously not known to each other.

### SUMMARY

In at least one implementation, the disclosed technology provides a method of generating a query including receiving at least sensed data of a first sensor collected from a first sensor on a querying device and sensed data of a second sensor collected from a second sensor on the querying device, where the sensed data of the first sensor and the sensed data of the second sensor are sensed contemporaneously by the querying device. The sensed data of the first sensor is transformed to obtain one or more numeric parameters. The sensed data of the second sensor is analyzed to identify one or more features using pattern recognition and the one or more features are extracted from the sensed data of the second sensor. The method further includes generating a query based at least on the numeric parameters obtained from the sensed data of the first sensor and the features extracted from the sensed data of the second sensor. The query is initiated for multimedia content on a shared dataset of multimedia content including data collected from one or more sharing devices. The method further includes receiving one or more multimedia results satisfying the query.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example querying device and an example sharing device capturing data regarding the same object.

FIG. 2 illustrates an example querying device and an example sharing device sharing captured data regarding the same object.

FIG. 3 illustrates an example querying device.

FIG. 4 illustrates another example querying device.

FIG. 5 illustrates example communications between a querying device, a network, and a sharing device.

FIG. 6 illustrates example operations for generating a query and initiating the query on a shared dataset of multimedia content.

FIG. 7 illustrates an example computing device for generating queries based on numeric parameters extracted from sensed data of a first sensor and pattern-recognized features extracted from sensed data of a second sensor.

### DETAILED DESCRIPTIONS

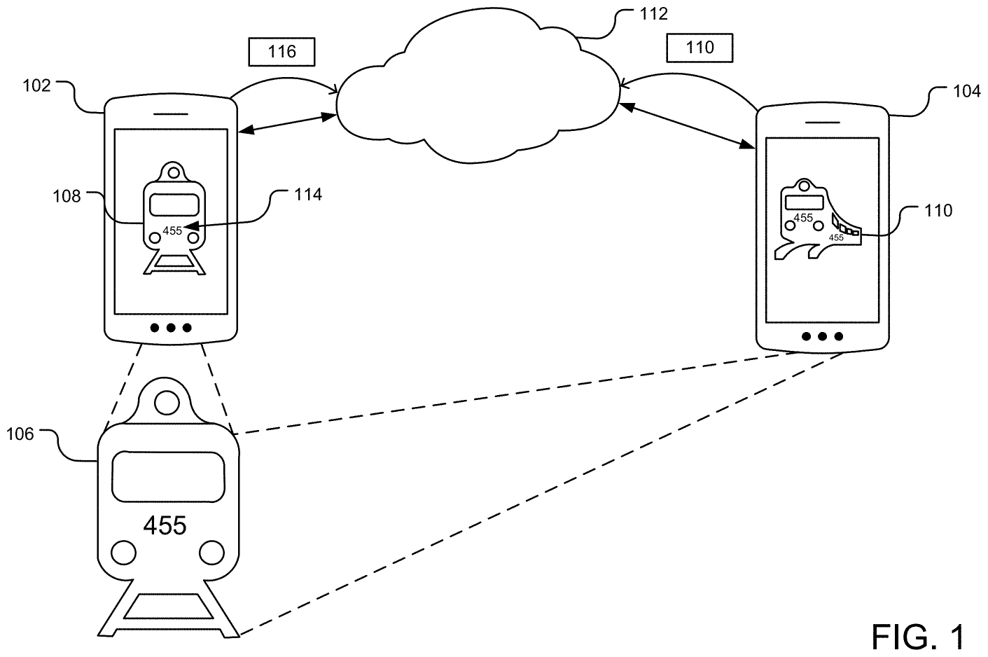

FIG. 1 illustrates an example querying device 102 and an example sharing device 104 capturing data regarding the same object 106. As shown in FIG. 1, a user using the querying device 102 may have a front view of an object 106 to capture an image of the object 106 using a first sensor on the querying device 102. Meanwhile, various users of other devices (e.g., the sharing device 104) may capture an image (or other multimedia content) of the object 106 from a different perspective. The user of the querying device 102 may wish to obtain images (or other multimedia content) of the object 106 captured by the user of the sharing device 104 but may not know the user of the sharing device 104 and may not be able to effectively search for other multimedia of the same object 106 captured in a similar location.

The querying device 102 has captured an image 108 of the object 106 using a second sensor on the querying device 102. The sharing device 104 has also captured an image 110 of the object 106 from a different perspective using a second sensor on the sharing device 104. After capturing the image 110, the sharing device 104 may send the image 110 to a shared storage location in a network 112 (e.g., the cloud) along with data sensed by a first sensor on the sharing device 104, such as global positioning satellite (GPS) data, temperature data, pressure data, etc. The data sensed by the first sensor on the sharing device 104 is collected contemporaneously with the capture of the image 110 by the second sensor on the sharing device 104. In some implementations, the sharing device 104 may share the image 110 without any associated data sensed by the first sensor on the sharing device 104.

To locate the image 110, a query is generated based on features extracted from the image 108 captured by the second sensor of the querying device and numeric parameters obtained from sensed data collected by the first sensor of the querying device 102. The sensed data collected by the first sensor of the querying device 102 is sensed contemporaneously with the capture of the image 108 by the second sensor on the querying device 102. For example, the number 114 on the object 106 in the image 108 is one example of a feature of the image 108. Other features may include, for example, words on an image or shown in a video, shapes shown in an image or audio file, or words spoken in a video or audio file. Numeric parameters obtained from sensed data collected by the second sensor on the querying device 102 may include, for example, GPS coordinates of the querying device 102, the altitude of the querying device 102, or the temperature of the querying device 102. In some implementations, the features are extracted from the image 108 and the sensed data sensed by the first sensor is transformed to obtain numeric parameters before a query 116 is sent to the network 112. In these implementations, the features are extracted from the image 108 and the numeric parameters are obtained from the sensed data collected by the first sensor on the querying device 102. In other implementations, the querying device 102 sends the image 108 and the sensed data sensed by the first sensor on the querying device 102 to the network 112 and the features are extracted from the image 108 and the numeric parameters are obtained from the sensed data sensed by the first sensor on the querying device 102 at a location on the network 112.

A query is generated using the features extracted from the image 108 and the numeric parameters obtained from the sensed data collected by the first sensor on the querying device 102. For example, when the sensed data collected by the first sensor is transformed to obtain numeric parameters in the form of the GPS coordinates of the querying device 102 and the feature extracted from the image 108 is the number 114 on the object 106, the query will be generated to search for multimedia including the same number 114 collected at the same or similar GPS coordinates. In some implementations, the user of the querying device 102 may be able to filter the results of the query or put filters on the query before the query is generated. For example, if many features are extracted from the image 108, the user of the querying device 102 may be able to decide which features may be relevant to a search. Additionally, where the numeric parameters are GPS data, the user of the querying device 102 may be able to set a range of GPS coordinates to search as part of the query.

Once the query is generated, the query is initiated on a shared dataset. The shared dataset includes data collected from sharing devices, such as the image 110 collected by the sharing device 104. Here, the query would likely return the image 110 to the user of the querying device 112.

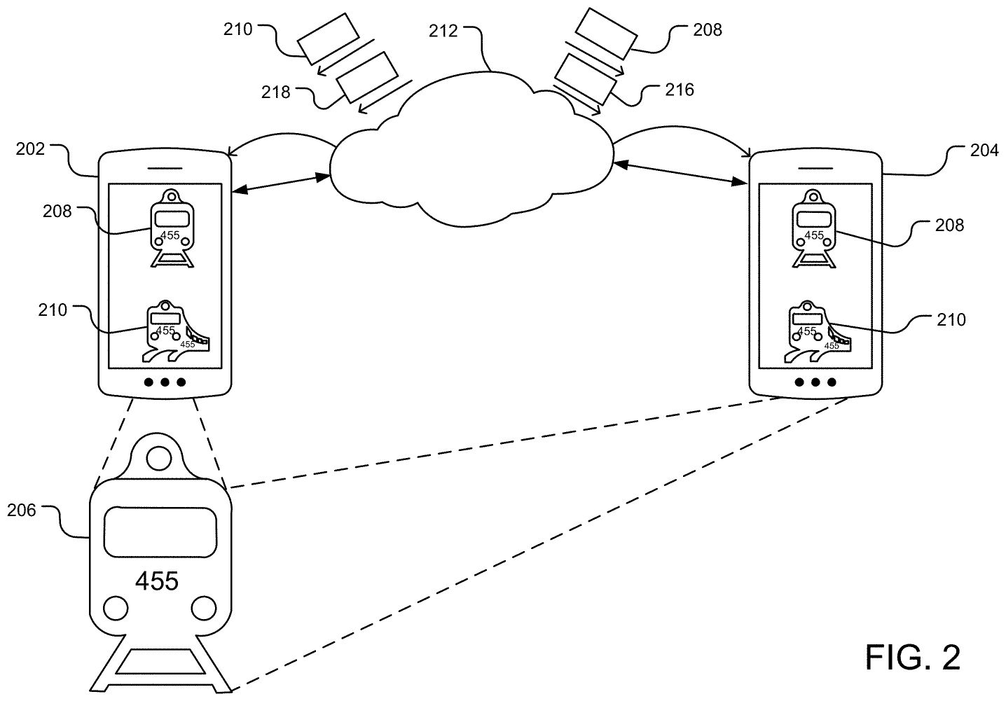

FIG. 2 illustrates an example querying device 202 and an example sharing device 204 sharing captured data regarding the same object 206. A query has been generated based on features extracted from an image 208 captured by a second sensor on the querying device 202 and the sensed data of a first sensor of the querying device 202 has been transformed to obtain numeric parameters. The query is initiated on a shared dataset of multimedia content, including an image 210 of the object 206 captured by the sharing device 204 and sent to a network 212. If, for example, the feature extracted from the image 208 is a number 214 on the object 206 and the numeric parameter obtained from sensed data of the first sensor of the querying device 202 is the GPS coordinates of the querying device 202, the initiation of the query may return the image 210 captured by the sharing device 204 as a result. In some implementations, whether the image 210 captured by the sharing device 204 is returned as a result may depend on filters set by the user of the querying device 202 when the query is generated. For example, in some implementations, the user of the querying device 202 may limit the query to a specific geographic radius.

The user of the querying device 202 may send a request 216 to the sharing device 204 to ask for permission to access the image 210 captured by the sharing device 204 when the image 210 is returned as a result of the query. In some implementations, when the request 216 is sent and accepted by the sharing device 204, the sharing device 204 gains access to the image 208 captured by the querying device 202 used to generate the query. In other implementations, the user of the sharing device 204 may choose to send a second request 218 to the querying device 202 for access to the image 208 and other images and multimedia captured by the querying device 202. After the sharing device 204 has accepted the request 216, the querying device 202 receives the image 210. In some implementations, the sharing device 204 also receives the image 208 after accepting the request 216. In other implementations, the sharing device 204 receives the image 208 after the querying device has accepted the second request 218. The request 216 and the second request 218 may be sent over a communications network 212.

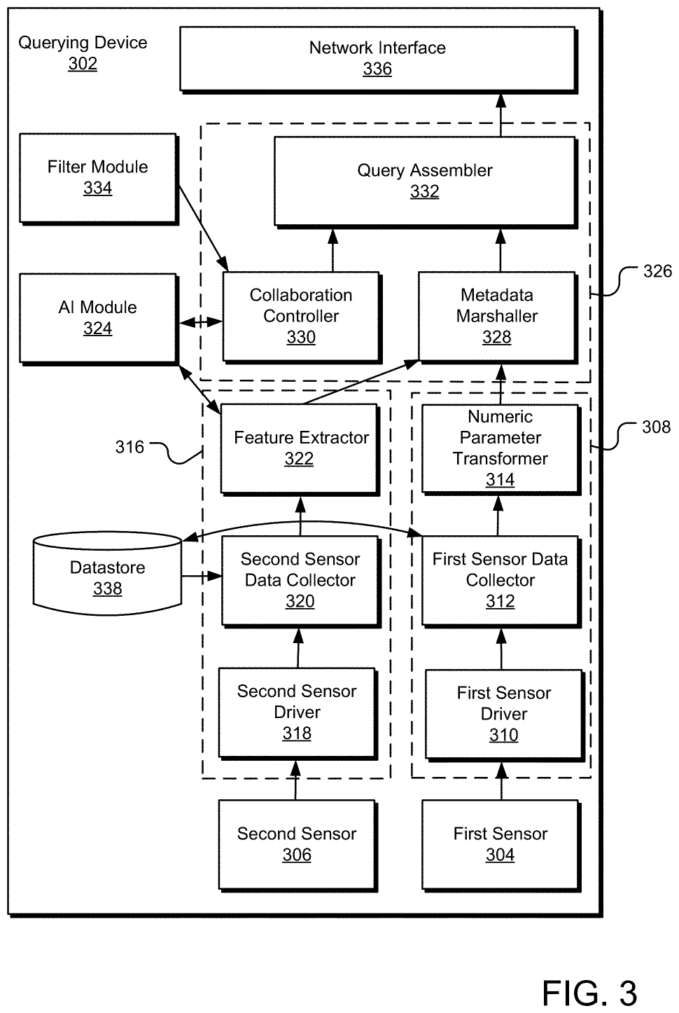

FIG. 3 illustrates an example querying device 302. The querying device 302 includes a first sensor 304 and a second sensor 306. A first sensor pipeline 308 includes a first sensor driver 310, a first sensor data collector 312, and a numeric parameter transformer 314. The first sensor pipeline 308 transforms the raw data collected by the first sensor 304 to the obtained numeric parameters used to generate the query. The first sensor 304 may be any type of sensor that senses data that may be used to create numeric parameters. For example, the first sensor 304 may be, without limitation, a GPS device, an altimeter sensor, a temperature sensor, an accelerometer, an ambient light sensor, a temperature sensor, a gyroscope, or any other sensor capable of generating numeric parameters on the querying device 302. The sensed data of the first sensor may be, for example and without limitation, GPS data, altimeter data, or data about the orientation of the first sensor relative to three dimensions.

In one exemplary implementation, the first sensor 304 is a GPS device collecting GPS data. When the first sensor 304 collects raw GPS data, the raw GPS data is sent to the first sensor driver 310 so that the raw GPS data can be communicated with the other elements in the first sensor pipeline 308. The first sensor data collector 312 collects the raw GPS data. In some implementations, the first sensor data collector 312 may store the raw GPS data until a query is generated. When the command to generate a query is initiated, the numeric parameter extractor 314 extracts numeric parameters from the raw GPS data. In one example, the raw GPS data received by the first sensor 304 is the location of the querying device 302 relative to three different satellites. The numeric parameter transformer 314 may triangulate the raw GPS data received by the first sensor 304 to obtain the GPS coordinates of the querying device 302. In other implementations, when the first sensor 304 is a different type of sensor, the numeric parameter transformer 314 may perform different calculations to obtain numeric parameters from the data collected by the first sensor 304.

A second sensor pipeline 316 includes a second sensor driver 318, a second sensor data collector 320, and a feature extractor 322. The second sensor pipeline 316 processes the data collected by the second sensor 306 to obtain the extracted features used to generate the query. The second sensor 306 is generally a sensor that can collect multimedia data, such as images, audio clips, or video clips. In some implementations, the second sensor 306 may be a collection of sensors. For example, the second sensor 306 may be both a camera and a microphone to capture a video clip.

In an exemplary embodiment, the second sensor 306 is a camera capturing still images. When the second sensor 306 collects an image, the image is sent to the second sensor driver 318 to be communicated to the rest of the second sensor pipeline 316. The second sensor data collector 320 collects images collected by the second sensor 306 and communicated through the second sensor driver 318. The sensor data collector 320 may store multiple images collected by the second sensor 306 until the user wants to generate a query based on images collected by the second sensor 306. In some implementations, the sensor data collector stores the images along with other metadata associated with the images, such as the time the images were captured. In some implementations, the sensor data collector 320 may receive images or other multimedia data from a datastore 338 located locally on the querying device 302 instead of sensed data sensed by the second sensor 306. In some implementations, the first sensor may also store data in the datastore 338. When the command to generate a query is initiated, the feature extractor 322 extracts features from the images.

The feature extractor 322 may extract several types of features from multimedia data collected by the second sensor 306 using pattern recognition and input from an artificial intelligence (AI) module 324. For example, when the second sensor is a camera, the feature extractor 322 may extract text present in still images, such as words or numbers on signs present in the image. The feature extractor 322 may also extract shapes present in the image through pattern recognition by comparing shapes in the images with known shapes contributed by the AI module 324. For multimedia data other than images, the feature extractor 322 may extract other features. For example, in video clips and audio clips, the feature extractor 322 may extract human speech or other sounds using pattern recognition. For example, the AI module 324 may store patterns that it has identified as the sound of certain words being spoken. The feature extractor 322 may recognize those patterns in an audio clip or video clip and extract the words being spoken as a feature of the video clip or audio clip.

After the feature extractor 322 and the numeric parameter transformed 314 have extracted features from data collected by the second sensor 306 and obtained numeric parameters from data collected by the first sensor 304, a query generator 326 uses the extracted features and the obtained numeric parameters to generate a query. The query generator 326 includes a metadata marshaller 328, a collaboration controller 330, and a query assembler 332.

The metadata marshaller 328 receives extracted features from the feature extractor 322 and numeric parameters from the numeric parameter transformer 314. The metadata marshaller 328 uses metadata associated with the extracted features and the obtained numeric parameters to pair corresponding extracted features and numeric parameters. Extracted features and numeric parameters are corresponding when the features are extracted from multimedia data sensed by the second sensor 306 contemporaneously with sensed data sensed by the first sensor 304 transformed to obtain the numeric parameters. When more than one feature is extracted from one piece of multimedia data (for, example, multiple features are extracted from one image), one numeric parameter may correspond to multiple features. This pairing of corresponding extracted features and numeric parameters allows the query to search for multimedia data containing certain features collected under certain conditions. For example, the query may search for multimedia containing a certain text pattern taken in a similar geographic area (indicated by GPS coordinates) as the multimedia data collected by the second sensor 306.

The collaboration controller 330 receives input from the AI module 324 and a filter module 334 to provide additional parameters to the query. The filter module 334 may allow the user of the querying device 302 to specify what to include in the query through additional user input to the filter module 334. For example, the user of the querying device 302 may choose to generate a query based on some features extracted from an image, but not on other features. Further, in some implementations, the user may choose ranges of similar numeric parameters to search using the query. For example, the user may choose a distance from the GPS coordinates of the querying device 302 to include in the query. In another example, when the sensed data of the first sensor is data about the orientation of the first sensor in three dimensions, the user may choose to search for multimedia data from a device with a field of view overlapping the field of view of the first sensor. The collaboration controller 330 may communicate with the AI module 324.

Information from the collaboration controller 330 and the metadata marshaller 328 is passed to the query assembler 332. The query assembler formulates a query based on the information received from the collaboration controller 330 and the metadata marshaller 328. For example, the query assembler 332 may formulate a query to search for multimedia containing certain text within a 0.1-mile radius of the GPS coordinates obtained from the sensed data of the first sensor 304. The query assembler 332 may send the formulated query to a network interface 336 to be communicated to a communications network where multimedia content is stored.

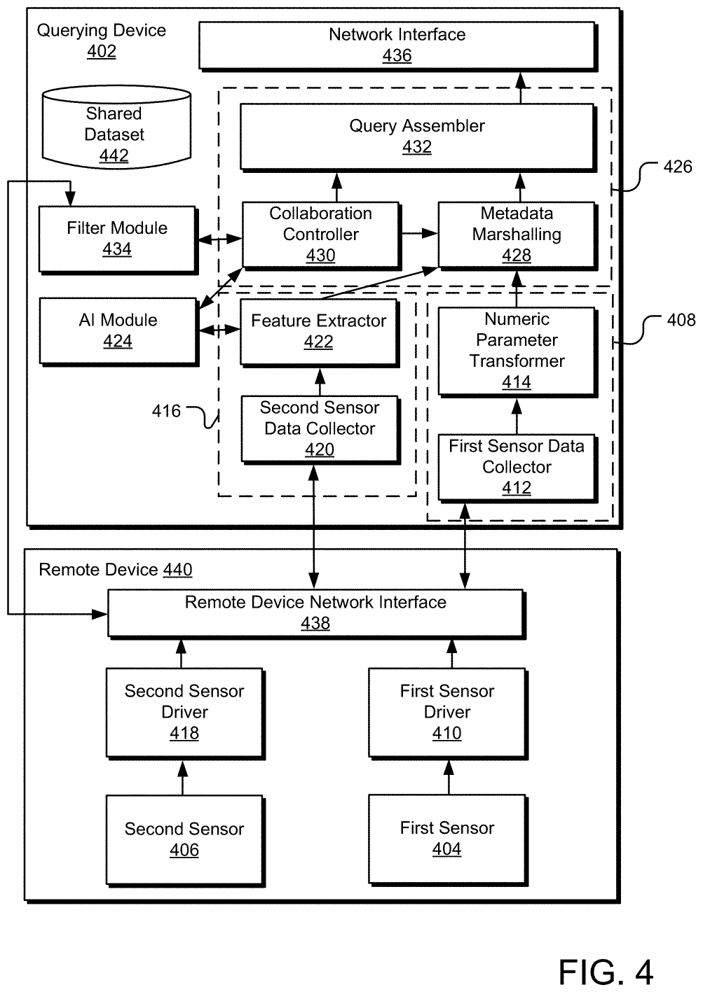

While the first sensor pipeline 308, the second sensor pipeline 316, and the query generator 326 are shown located on the querying device 302, in other implementations, all or individual portions of the first sensor pipeline 308, the second sensor pipeline 316, and the query generator 326 may be located on a separate computing device from the first sensor 304 and the second sensor 306. An alternative implementation is discussed in more detail with reference to FIG. 4.

FIG. 4 illustrates another example querying device 402. The example querying device 402 is separate from a remote device 440 containing a first sensor 404 and a second sensor 406. The querying device 402 includes a first sensor pipeline 408 containing a first sensor data collector 412 and a numeric parameter transformer 414. The querying device 402 also includes a second sensor pipeline 416 containing a second sensor data collector 420 and a feature extractor 422. The querying device 402 further includes a query generator 426 including a metadata marshaller 428, a collaboration controller 430, and a query assembler 432. In some implementations, the querying device 402 also includes an AI module 424, a filter module 434, and a network interface 436. The querying device 402 may be any type of computing device, including, without limitation, a mobile device, a computer, a remote server, or a communications network based device.

The first sensor 404 senses data on the remote device 440 and passes the raw sensed data to a first sensor driver 410, also located on the remote device 440. The first sensor 404 may be any type of sensor that senses data that may be used to create numeric parameters. For example, the first sensor 404 may be, without limitation, a GPS device, an altimeter sensor, a temperature sensor, an accelerometer, an ambient light sensor, a temperature sensor, a gyroscope, or any other sensor capable of generating numeric parameters. The first sensor driver 410 communicates the raw sensed data to a remote device network interface 438 to be communicated to a first sensor pipeline 408 located on the querying device 402. The elements of the first sensor pipeline 408 work together to transform the sensed data of the first sensor 404 to obtain numeric parameters.

The second sensor 406 senses data and passes the raw data to a second sensor driver 418, also located on the remote device 440. The second sensor 406 is generally a sensor that can collect multimedia data, such as images, audio clips, or video clips. In some implementations, the second sensor 406 may be a collection of sensors. For example, the second sensor 406 may be both a camera and a microphone to capture a video clip. The second sensor driver 418 communicates the raw sensor data to the remote device network interface 438 for communication to the second sensor pipeline 416 on the querying device 402. The elements of the second sensor pipeline 416 work together to extract features from the sensed data of the second sensor 406.

The elements of the query generator 426 work together to generate a query. The metadata marshaller 428 receives extracted features from the feature extractor 422 and numeric parameters from the numeric parameter transformer 414. The metadata marshaller 428 then pairs extracted features with corresponding numeric parameters. The collaboration controller 430 receives input from a filter module 434 and the AI module 424. When the first sensor 404 and the second sensor 406 are located on the remote device 440, the filter module 434 may send requests and receive user input from the remote device 440. For example, the filter module 434 may send the remote device 440 a request to specify which features to include in a query and may receive user input regarding which features to include in the query from the remote device 440. The collaboration controller 430 and the metadata marshaller 428 send information to the query assembler 432 to assemble the appropriate query.

In some implementations, the query assembler 432 communicates the query to a network interface 436. The network interface 436 may then communicate the query to another device via a communications network. In other implementations, the query may be initiated on a shared dataset of multimedia content 442 located locally on the querying device 442. The network interface 436 may be used to communicate with other devices over a communications network, such as Wi-Fi or a cellular network.

Though FIG. 4 shows the first sensor pipeline 408, the second sensor pipeline 416, and the query generator 426 on the querying device 402, in other implementations, the components may be divided differently between the querying device 402 and the remote device 440. For example, the query generator 426 may be located on the querying device 402, while the first sensor pipeline 408 and the second sensor pipeline 416 may be located on the remote device 440. In yet other implementations, some components may be located on a second remote device (not shown).

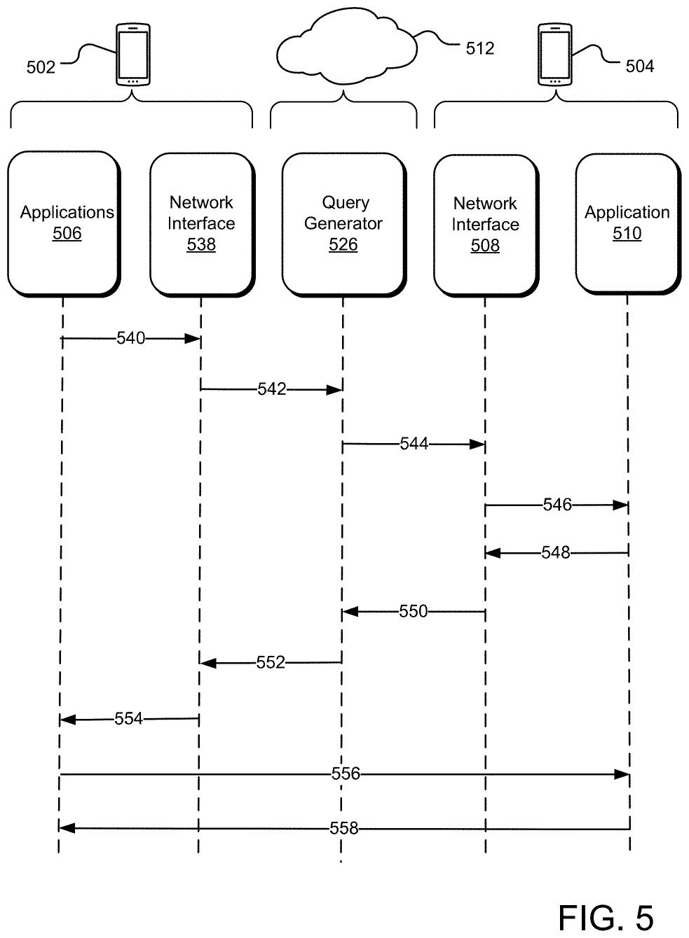

FIG. 5 illustrates example communications between a querying device 502, a communication network 512, and a sharing device 504. Applications 506 on the querying device 502 sense data at a first sensor and a second sensor. In a communication 540, the applications 506 communicate the sensed data of the first sensor and the sensed data of the second sensor to a network interface 538 of the querying device. In a communication 542, the network interface 538 communicates the sensed data of the first sensor and the sensed data of the second sensor to a query generator 526 located on a communication network 512.

The query generator 526 transforms the sensed data of the first sensor to obtain numeric parameters and extracts features from the sensed data of the second sensor. In some implementations, the applications 506 on the querying device 502 may obtain numeric parameters from the sensed data of the first sensor and extract features from the sensed data of the second sensor. The extracted features and numeric parameters may then be sent to the query generator 526 as part of the communication 542 from the network interface 538 of the querying device 502. The query generator 526 uses the extracted features and the numeric parameters to generate a query for shared multimedia data. In some implementations, the query may be generated by the applications 506 of the querying device 502 and sent to the communication network 512 as part of the communication 542 from the network interface.

Once the query is generated, it is initiated by the query generator 526 on a shared dataset of multimedia content located on the communication network 512. The shared dataset of multimedia content may include multimedia content collected by the sharing device 504. If the query returns a piece of multimedia content collected by the sharing device 504, the query generator 526 may send a communication 544 to the network interface 508 of the sharing device 504. The communication 544 includes a request to share multimedia content with the querying device 502. A communication 546 sends the request to share multimedia content to an application 510 on the sharing device 504.

The application 510 on the sharing device 504 present the request to a user of the sharing device 504. If the user accepts the request, a communication 548 sends the request from the application 510 of the sharing device 504 to the network interface 508 of the sharing device 504. A communication 550 sends the acceptance of the request to the query generator 526 of the communication network 512.

When the query generator 526 of the communication network 512 receives the communication 550 with the acceptance, the query generator 526 retrieves the relevant multimedia data from the shared dataset of multimedia content. A communication 552 communicates the relevant multimedia data to the network interface 538 of the querying device 502. A communication 554 communicates the relevant multimedia data to the application 506 of the querying device 506. In some implementations, the relevant multimedia data may be saved to a local library on the querying device 502.

In some implementations, after the relevant multimedia data is communicated to the querying device in the communication 554, the querying device 502 and the sharing device 504 are directly linked and may communicate other multimedia data (or other data) directly (e.g., through a communication 556 from the querying device 502 to the sharing device 504 or through a communication 558 from the sharing device 502 to the querying device 502). The direct communication between the querying device 502 and the sharing device 504 may occur through the communication network 512, through short message service (SMS), or through any other method of communication between devices.

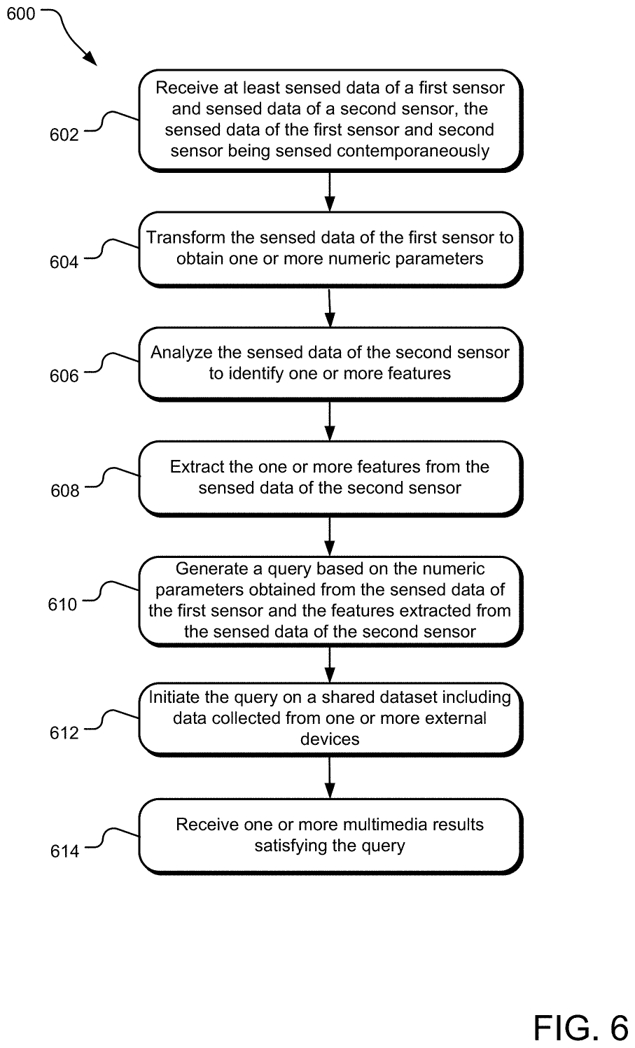

FIG. 6 illustrates example operations for generating a query and initiating the query on a shared dataset of multimedia content. A receiving operation 602 receives at least sensed data of a first sensor and sensed data of a second sensor, the sensed data of the first sensor and the sensed data of the second sensor being sensed contemporaneously. The sensed data of the first sensor may be any type of raw data collected from the first sensor. The first sensor may be any type of sensor that senses data that may be used to create numeric parameters. For example, the first sensor may be, without limitation, a GPS device, an altimeter sensor, a temperature sensor, an accelerometer, an ambient light sensor, a temperature sensor, a gyroscope, or any other sensor capable of generating numeric parameters on the querying device. The sensed data of the second sensor may be a type of multimedia data, such as a still image, a video clip, or an audio clip. The second sensor is generally a sensor that can collect multimedia data, such as images, audio clips, or video clips. In some implementations, the second sensor may be a collection of sensors. For example, the second sensor may be both a camera and a microphone to capture a video clip.

A transforming operation 604 transforms the sensed data of the first sensor to obtain one or more numeric parameters. The numeric parameters may be obtained using different techniques depending on the data type of the sensed data of the first sensor. For example, when the data type of the sensed data of the first sensor is raw GPS data, the transforming operation 604 may use triangulation to determine the GPS coordinates of the first sensor. Or, when the data type of the sensed data of the first sensor is raw altimeter data, the transforming operation 604 may convert pressure data to the altitude of the first sensor.

An analyzing operation 606 analyzes the sensed data of the second sensor to identify on or more features using pattern recognition. A feature of the sensed data of the second sensor may be, for example and without limitation, text in an image or video clip, a shape in an image or video clip, spoken words in a video clip or audio clip, or a sound of a certain frequency and length in a video clip or audio clip. The sensed data of the second sensor may be analyzed using input from an AI module or with assistance from a user. An AI module may compare elements present in the sensed data of the second sensor to known features to identify features in the sensed data of the second sensor.

An extracting operation 608 extracts the one or more features from the sensed data of the second sensor. The extracting operation 608 extracts the features identified by the analyzing operation 606 from the sensed data of the second sensor. The sensed data of the second sensor may include one or more than one feature. For example, a video clip may include a variety of features such as spoken words, shapes, and text patterns in the images of the video.

A generating operation 610 generates a query based on the numeric parameters obtained from the sensed data of the first sensor and the features extracted from the sensed data of the second sensor. In some implementations, the generating operation 610 uses input from a user along with the numeric parameters obtained from the sensed data of the first sensor and the features extracted from the sensed data of the second sensor to generate a query. For example, a user may specify which features extracted in the extracting operation 608 should be included in the query. Or, the user may specify a range of numeric parameters to include in the query. In other implementations, the generating operation 610 uses supplemental information along with the numeric parameters obtained from the sensed data of the first sensor and the features extracted from the sensed data of the second sensor to generate a query. For example, a user may specify additional features or numeric paramaters to be included in the query.

An initiating operation 612 initiates the query on a shared dataset including data collected from one or more external devices. The shared dataset including data collected from one or more external devices may include multimedia data including metadata that may be searched to return results satisfying the query. For example, shared images from external devices may include GPS, altitude, time, temperature, or other data about the external device when the image was captured.

A receiving operation 614 receives one or more multimedia results satisfying the query. In some implementations, the receiving operation 614 may not return any results because no multimedia satisfies the query. When no multimedia satisfies the query, the user may be presented with the option to generate a new query with, for example, a wider range of numeric parameters. In some implementations, the receiving operation 614 may return a preview of the multimedia results to the querying device. The user may select from the previews and send requests to external devices with multimedia content that the user wishes to access.

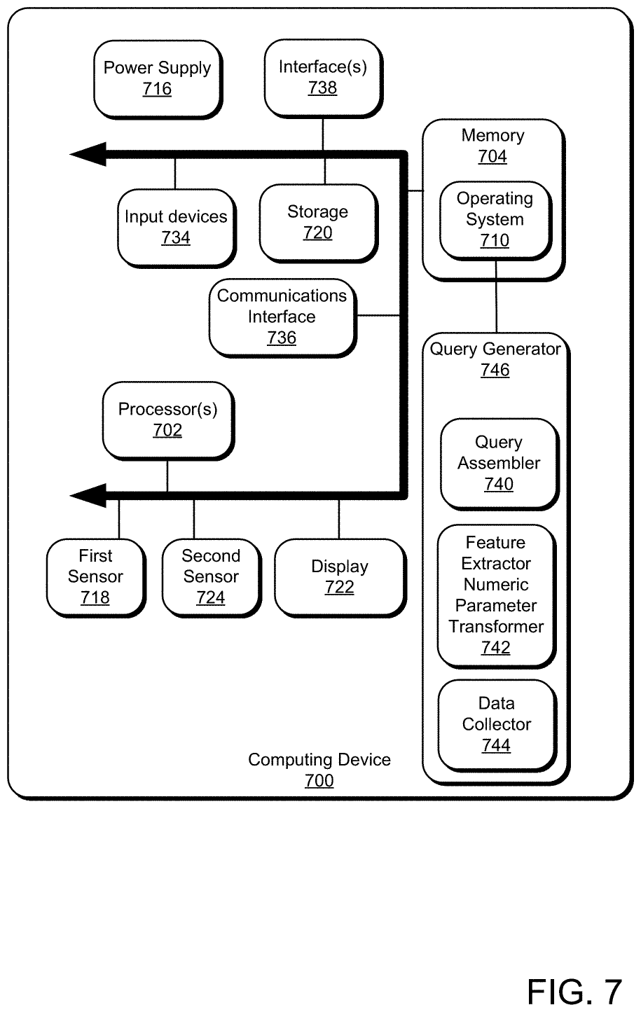

FIG. 7 illustrates an example computing device 700 for generating queries based on numeric parameters extracted from sensed data of a first sensor 718 and pattern-recognized features extracted from sensed data of a second sensor 724. The computing device 700 may be a client device, such as a laptop, mobile device, desktop, tablet, or a server/cloud device. The computing device 700 includes one or more processor(s) 702, and a memory 704. The memory 704 generally includes both volatile memory (e.g., RAM) and non-volatile memory (e.g., flash memory). An operating system 710 resides in the memory 704 and is executed by the processor(s) 702.

One or more modules or segments, such as a query generator 746 are loaded into the operating system 710 on the memory 704 and/or storage 720 and executed by the processor(s) 702. The modules may include the query generator 746 implemented by a query assembler 740, a feature extractor and numeric parameter transformer 742, and a data collector 744. The query generator 746 generates queries based on numeric parameters obtained from transformed sensed data sensed by the first sensor 718 and features extracted from sensed data sensed by the second sensor 724 on the computing device 700.

The query generator 746 includes the query assembler 740, the feature extractor and numeric parameter transformer 742, and the data collector 744. The data collector 744 receives sensed data of the first sensor 718 collected from the first sensor 718 and sense data of the second sensor 724 collected from the second sensor 724. In some implementations, the data collector 744 may receive sensed data sensed by a first remote sensor and a second remote sensor, where neither the first remote sensor nor the second remote sensor is located on the computing device 700. The feature extractor and numeric parameter transformer 742 transforms the sensed data of the first sensor to obtain one or more numeric parameters. The feature transformer and numeric parameter extractor 742 further analyzes the sensed data of the second sensor to identify one or more features using pattern recognition and extracts the one or more features from the sensed data of the second sensor. The query assembler 740 generates a query based on the numeric parameters obtained from the sensed data of the first sensor and the features extracted from the sensed data of the second sensor.

Data such as user preferences, hardware configurations, and hardware responses may be stored in the memory 704 or storage 720 and may be retrievable by the processor(s) 702 for use by the query assembler 740, the feature extractor and numeric parameter transformer 742, and the data collector 744. The storage 720 may be local to the computing device 700 or may be remote and communicatively connected to the computing device 700 and may include another server. The storage 720 may store resources that are requestable by client devices (not shown).

The computing device 700 includes a power supply 716, which is powered by one or more batteries or other power sources and which provides power to other components of the computing device 700. The power supply 716 may also be connected to an external power source that overrides or recharges the built-in batteries or other power sources.

The computing device 700 may include one or more communication transceivers which may be connected to one or more antenna(s) to provide network connectivity (e.g., mobile phone network, Wi-Fi®, Bluetooth®) to one or more other servers and/or client devices (e.g., mobile devices, desktop computers, or laptop computers) through a communications interface 736. The computing device 700 may further include a network adapter, which is a type of communication device. The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard or mouse). These and other input devices may be coupled to the server by one or more interfaces 738 such as a serial port interface, parallel port, or universal serial bus (USB). The computing device 700 may further include a display 722 such as a touch screen display.

The computing device 700 may include a variety of tangible processor-readable storage media and intangible processor-readable communication signals. Tangible processor-readable storage can be embodied by any available media that can be accessed by the computing device 700 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

An example computing device is provided. The computing device includes one or more processors and a first data sensor data collector executed by the one or more processors of the computing device. The first sensor data collector is configured to receive at least sensed data of a first sensor collected from a first sensor on a querying device. The computing device further includes a second sensor data collector executed by the one or more processors of the computing device. The second sensor data collector is configured to receive sensed data of a second sensor collected from a second sensor on the querying device. The sensed data of the first sensor and the sensed data of the second sensor are sensed contemporaneously by the querying device. A numeric parameter transformer is executed by the one or more processors of the computing device. The numeric parameter transformer is configured to transform the sensed data of the first sensor to obtain one or more numeric parameters. A feature extractor is executed by the one or more processors of the computing device. The feature extractor is configured to analyze the sensed data of the second sensor to identify one or more features using pattern recognition and to extract the one or more features from the sensed data of the second sensor. A query generator is executed by the one or more processors of the computing device. The query generator is configured to generate a query based at least on the numeric parameters obtained from the sensed data of the first sensor and the features extracted from the sensed data of the second sensor. The query generator is further configured to initiate the query for multimedia content on a shared dataset of multimedia content including data collected from one or more sharing devices and to receive one or more multimedia results satisfying the query.

An example computing device of any previous computing device is provided, where the query is generated based further on supplemental information provided to the computing device.

An example computing device of any previous computing device is provided, where the data collected from the one or more sharing devices included in the shared dataset of multimedia content includes multimedia data including metadata.

An example computing device of any previous computing device is provided, where the query generator is further configured to generate a request to share multimedia data with the one or more sharing devices.

An example computing device of any previous computing device is provided, where the sensed data of the first sensor includes orientation data relative to three dimensions.

An example computing device of any previous computing device is provided, where the second sensor data collector is further configured to receive previously sensed data of the second sensor from a datastore, the previously sensed data of the second sensor being sensed by the second sensor and stored on the datastore.

An example computing device of any previous computing device is provided, where the query generator includes a collaboration controller configured to receive user parameters to generate the query. The query generator also includes a metadata marshaller configured to pair the one or more numeric parameters with corresponding extracted features of the one or more extracted features. The query generator also includes a query assembler. The query assembler is configured to assemble the query based on the paired one or more numeric parameters with corresponding extracted features of the one or more extracted features and the received user parameters.

An example computing device of any previous computing device is provided, where the computing device further includes a filter module configured to receive user input to generate the query and to communicate the received user input to the query generator.

An example method is provided. The method includes receiving at least sensed data of a first sensor collected from a first sensor on a querying device and sensed data of a second sensor collected from a second sensor on the querying device. The sensed data of the first sensor and the sensed data of the second sensor are sensed contemporaneously by the querying device. The method further includes transforming the sensed data of the first sensor to obtain one or more numeric parameters and analyzing the sensed data of the second sensor to identify one or more features using pattern recognition. The method includes extracting the one or more features from the sensed data of the second sensor and generating a query based at least on the numeric parameters obtained from the sensed data of the first sensor and the features extracted from the sensed data of the second sensor. The method also includes initiating the query for multimedia content on a shared dataset of multimedia content including data collected from one or more sharing devices and receiving one or more multimedia results satisfying the query.

A method of any previous method is provided, where the query is generated further based on supplemental information provided to the querying device.

A method of any previous method is provided, where the data collected from the one or more sharing devices included in the shared dataset of multimedia content includes multimedia data including metadata.

A method of any previous method is provided, where the method further includes generating a request to share multimedia data with one or more sharing devices.

A method of any previous method is provided, where the query is generated based further on user input.

An example system includes means for receiving at least sensed data of a first sensor collected from a first sensor on a querying device and sensed data of a second sensor collected from a second sensor on the querying device, the sensed data of the first sensor and the sensed data of the second sensor being sensed contemporaneously by the querying device. The system also includes means for transforming the sensed data of the first sensor to obtain one or more numeric parameters and analyzing the sensed data of the second sensor to identify one or more features using pattern recognition. The system also includes means for extracting the one or more features from the sensed data of the second sensor and generating a query based at least on the numeric parameters obtained from the sensed data of the first sensor and the features extracted from the sensed data of the second sensor. The system also includes means for initiating the query for multimedia content on a shared dataset of multimedia content including data collected from one or more sharing devices and receiving one or more multimedia results satisfying the query.

An example system of any preceding system is provided, where the query is generated further based on supplemental information provided to the querying device.

An example system of any preceding system is provided, where the data collected from the one or more sharing devices included in the shared dataset of multimedia content includes multimedia data including metadata.

An example system of any preceding system further includes means for generating a request to share multimedia data with the one or more sharing devices.

An example system of any preceding system is provided, where the sensed data of the first sensor includes orientation data relative to three dimensions.

An example system of any preceding system is provided, where the query is generated based further on user input.

Example one or more tangible processor-readable storage media are embodied with instructions for executing on one or more processors and circuits of a computing device a process including receiving at least sensed data of a first sensor collected from a first sensor on a querying device and sensed data of a second sensor collected from a second sensor on the querying device. The sensed data of the first sensor and the sensed data of the second sensor are sensed contemporaneously by the querying device. The process further includes transforming the sensed data of the first sensor to obtain one or more numeric parameters and analyzing the sensed data of the second sensor to identify one or more features using pattern recognition. The process also includes extracting the one or more features from the sensed data of the second sensor and generating a query based at least on the numeric parameters obtained from the sensed data of the first sensor and the features extracted from the sensed data of the second sensor. The process also includes initiating the query for multimedia content on a shared dataset of multimedia content including data collected from one or more sharing devices and receiving one or more multimedia results satisfying the query.

Another example one or more tangible processor-readable storage media are embodied with instructions for executing on one or more processors and circuits of a device a process of any preceding process where the query is generated further based on supplemental information provided to the querying device.

Another example one or more tangible processor-readable storage media are embodied with instructions for executing on one or more processors and circuits of a device a process of any preceding process where the data collected from the one or more sharing devices included in the shared dataset of multimedia content includes multimedia data including metadata.

Another example one or more tangible processor-readable storage media are embodied with instructions for executing on one or more processors and circuits of a device a process of any preceding process, further including generating a request to share multimedia data with the one or more sharing devices.

Another example one or more tangible processor-readable storage media are embodied with instructions for executing on one or more processors and circuits of a device a process of any preceding process where the sensed data of the first sensor includes orientation data relative to three dimensions.

Another example one or more tangible processor-readable storage media are embodied with instructions for executing on one or more processors and circuits of a device a process of any preceding process where the query is generated based further on user input.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computing device comprising:
one or more processors;
a first sensor data collector executed by the one or more processors of the computing device, the first sensor data collector configured to receive at least sensed data of a first sensor collected from a first sensor on a querying device;
a second sensor data collector executed by the one or more processors of the computing device, the second sensor data collector configured to receive sensed data of a second sensor collected from a second sensor on the querying device, the sensed data of the first sensor and the sensed data of the second sensor being sensed contemporaneously by the querying device;
a numeric parameter transformer executed by the one or more processors of the computing device, the numeric parameter transformer configured to transform the sensed data of the first sensor to obtain one or more numeric parameters;
a feature extractor executed by the one or more processors of the computing device, the feature extractor configured to analyze the sensed data of the second sensor to identify one or more features using pattern recognition and to extract the one or more features from the sensed data of the second sensor; and
a query generator executed by the one or more processors of the computing device, the query generator configured to:
generate a query based at least on the numeric parameters obtained from the sensed data of the first sensor and the features extracted from the sensed data of the second sensor,
initiate the query for multimedia content on a shared dataset of multimedia content including data collected from one or more sharing devices, and
receive one or more multimedia results satisfying the query.

2. The computing device of claim 1, wherein the query is generated based further on supplemental information provided to the computing device.

3. The computing device of claim 1, wherein the data collected from the one or more sharing devices included in the shared dataset of multimedia content includes multimedia data including metadata.

4. The computing device of claim 1, wherein the query generator is further configured to generate a request to share multimedia data with the one or more sharing devices.

5. The computing device of claim 1, wherein the sensed data of the first sensor includes orientation data relative to three dimensions.

6. The computing device of claim 1, wherein the second sensor data collector is further configured to receive previously sensed data of the second sensor from a datastore, the previously sensed data of the second sensor being sensed by the second sensor and stored on the datastore.

7. The computing device of claim 1, wherein the query generator comprises:
a collaboration controller configured to receive user parameters to generate the query;
a metadata marshaller configured to pair the one or more numeric parameters with corresponding extracted features of the one or more extracted features; and
a query assembler configured to assemble to query based on the paired one or more numeric parameters with corresponding extracted features of the one or more extracted features and the received user parameters.

8. The computing device of claim 7, further comprising:
a filter module configured to receive user input to generate the query and to communicate the received user input to the query generator.

9. A method comprising:
receiving at least sensed data of a first sensor collected from a first sensor on a querying device and sensed data of a second sensor collected from a second sensor on the querying device, the sensed data of the first sensor and the sensed data of the second sensor being sensed contemporaneously by the querying device;
transforming the sensed data of the first sensor to obtain one or more numeric parameters;
analyzing the sensed data of the second sensor to identify one or more features using pattern recognition;
extracting the one or more features from the sensed data of the second sensor;
generating a query based at least on the numeric parameters obtained from the sensed data of the first sensor and the features extracted from the sensed data of the second sensor;
initiating the query for multimedia content on a shared dataset of multimedia content including data collected from one or more sharing devices; and
receiving one or more multimedia results satisfying the query.

10. The method of claim 9, wherein the query is generated further based on supplemental information provided to the querying device.

11. The method of claim 9, wherein the data collected from the one or more sharing devices included in the shared dataset of multimedia content includes multimedia data including metadata.

12. The method of claim 9, further comprising:
generating a request to share multimedia data with the one or more sharing devices.

13. The method of claim 9, wherein the sensed data of the first sensor includes orientation data relative to three dimensions.

14. The method of claim 9, wherein the query is generated based further on user input.

15. One or more tangible processor-readable storage media embodied with instructions for executing on one or more processors and circuits of a computing device a process comprising:
receiving at least sensed data of a first sensor collected from a first sensor on a querying device and sensed data of a second sensor collected from a second sensor on the querying device, the sensed data of the first sensor and the sensed data of the second sensor being sensed contemporaneously by the querying device;
transforming the sensed data of the first sensor to obtain one or more numeric parameters;
analyzing the sensed data of the second sensor to identify one or more features using pattern recognition;
extracting the one or more features from the sensed data of the second sensor;
generating a query based at least on the numeric parameters obtained from the sensed data of the first sensor and the features extracted from the sensed data of the second sensor;
initiating the query for multimedia content on a shared dataset of multimedia content including data collected from one or more sharing devices; and
receiving one or more multimedia results satisfying the query.

16. The one or more tangible processor-readable storage media of claim 15, wherein the query is generated further based on supplemental information provided to the querying device.

17. The one or more tangible processor-readable storage media of claim 15, wherein the data collected from the one or more sharing devices included in the shared dataset of multimedia content includes multimedia data including metadata.

18. The one or more tangible processor-readable storage media of claim 15, the process further comprising:
generating a request to share multimedia data with the one or more sharing devices.

19. The one or more tangible processor-readable storage media of claim 15, wherein the sensed data of the first sensor includes orientation data relative to three dimensions.

20. The one or more tangible processor-readable storage media of claim 15, wherein the query is generated based further on user input.
